(19) United States
(12) Patent Application Publication
(10) Pub. No.: US 2004/0236683 A1
(43) Pub. Date: Nov. 25, 2004

(54) Method and system for achieving control of invoicing for third-party services

(76) Inventors: Eulalie Guermonprez, Grenoble (FR); Sebastien Mugnier, Grenoble (FR); Juan Jane, Barcelona (ES)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/443,205

(22) Filed: May 21, 2003

(51) Int. Cl. G06F 17/60

(52) U.S. Cl. 705/40

(57) ABSTRACT

A method for achieving control of invoicing for third-party services is disclosed. The method includes receiving a proof-of-completion notice and generating an invoice to self on behalf of a provider of the third-party services. The invoice to self is generated in response to receiving the proof-of-completion notice.

### FIELD OF INVENTION

The present invention relates to the field of invoicing. In particular, the present invention relates to a method for self-invoicing based on receipt of completion of services performed by a third party.

### BACKGROUND

The provision of services by a third-party service provider (TSP) is a common practice in today's business environment. For example, many manufacturers today utilize TSPs for delivering goods ordered by their customers. In such an example, the manufacturer's Logistics Department is typically responsible for managing shipments of goods to their customers. When a customer places an order, the Logistics Department locates the goods ordered, frequently in a warehouse, and contacts a TSP requesting that they pick up the goods at the designated location and deliver them to the customer at the customer's designated location. The TSPs go to the manufacturer's designated location and pick up the goods for delivery.

At this point, the TSP generates an invoice and bills the manufacturer for the shipment. The Freight Cost Management group at the manufacturer's facility then matches the record and negotiated cost from the Logistics Department with the invoice received from the TSP, and if they match, the manufacturer's Finance Operation pays the TSP in the amount of the invoice.

This process has two major areas of concern. First, this assumes that the goods are delivered to the final destination. Not only does it assume that the shipment of goods is received by the customer, but it also assumes that the shipment was complete, delivered on time, and in good condition. Thus, if the shipment arrived damaged, incomplete, or never arrived at all, that information often is received after the TSP has been paid for their services. This results in having to reconcile the bill with the TSP at a later stage, and often leads to confusion and sometimes even to ill will.

A second concern is that the invoices generated by the TSP are not always generated properly. For example, the weight of the shipment might be in dispute or the rates might not be what the manufacturer has agreed to. Once the invoice is generated by the TSP and sent, the TSP is often resistant to making adjustments. Resolving TSP issues or disputes is time consuming, expensive, and can even sometimes lead to ill will.

### SUMMARY

A method for achieving control of invoicing for third-party services is disclosed. The method includes receiving a proof-of-completion notice and generating an invoice to self on behalf of a provider of the third-party services. The invoice to self is generated in response to receiving the proof-of-completion notice.

### BRIEF DESCRIPTION OF THE DRAWINGS

FIG. 1 is a flow diagram of a method for achieving control of invoicing for third-party services, in accordance with one embodiment of the present invention.

FIGS. 2A, 2B and 2C make up a flow chart for a method of self-invoicing for freight cost management, in accordance with one embodiment of the present invention.

FIG. 3 is a block diagram of a system for achieving control of invoicing for third-party services, in accordance with one embodiment of the present invention.

FIG. 4 illustrates an exemplary computer system platform upon which embodiments of the present invention can be practiced.

FIG. 5 is a flow diagram of a method for achieving control of invoicing for third party services, in accordance with one embodiment of the present invention.

### DETAILED DESCRIPTION

Reference will now be made in detail to embodiments of the invention, examples of which are illustrated in the accompanying drawings. While the invention will be described in conjunction with the embodiments, it will be understood that they are not intended to limit the invention to these embodiments. Furthermore, in the following detailed description, numerous specific details are set forth in order to provide a thorough understanding of the present invention. In other instances, well known methods, procedures, and components have not been described in detail so as not to unnecessarily obscure aspects of the present invention.

The following detailed description pertains to a method and system for achieving control of invoicing for third-party services. For purposes of clarity and brevity, the following discussion will explain the present method and system with respect to a third-party delivery service provider. It should be noted, however, that although such an example is explicitly provided below, the method and system of the present invention is well suited to use with various other types of third-party services providers including, but not limited to, delivery services providers.

Embodiments of the present invention include a method and a system for achieving control of invoicing for third-party services. The method, which can be executed on a computer useable medium with computer readable code, includes receiving a proof-of-delivery (POD) notice and generating an invoice-to-self on behalf of a provider of the third-party services. The invoice-to-self is generated in response to receiving the proof-of-completion notice. In one embodiment, the third-party services provider is referred to as a logistics service provider, a freight services provider, and a transportation services provider, but for purposes of clarity and consistency, in the present application we will use the term third-party services provider (TSP). Again, it should be noted that, although the above discussion explicitly recites a TSP which is a third-party delivery services provider and a POD, embodiments in accordance with the present invention are also well suited to use with other types of TSPs and proof-of-completion notices for services other than delivery services.

As an overview, in one embodiment, the method entails obtaining an advance shipment notice (ASN) and negotiated rates from a Logistics Department, also sometimes called Transportation Department, of a manufacturer's organization. The manufacturer's Freight Cost Management System stores and maintains rate structures. It also receives, by Electronic Data Interchange (EDI), all information related to every shipment (e.g., weight, TSP, origin, destination). Upon receiving the POD, the ASN is compared with the POD to assure that the proper rates were charged and that the shipment was delivered successfully without defect. The final cost of delivery is based on how the notices compare to each other. If the two notices do not match, the TSP is notified by an exception report and the invoice is not generated until resolution of the differences is achieved. If there is no resolution, the invoicing period expires and the invoice is discarded and not generated, thereby requiring the TSP to generate a new POD.

According to one embodiment, provided the ASN and the POD match, a further check is performed to determine whether the shipment was complete. If not, the TSP is notified by another exception report, and the delivered weights are adjusted accordingly. An invoice is then generated by the manufacturer, based on delivered weight and the manufacturer provides the TSP with the details of the invoice and it is sent to the manufacturer's Finance Operation for payment. The self-invoice prepared by the manufacturer on behalf of the TSP is deemed issued by the TSP for legal, tax and any other reasons.

Therefore, the concern regarding billing before delivered conditions are known is removed by requiring that the POD is received prior to invoicing. Further, the concern regarding billing based on incorrect rates, incomplete shipment or wrong cargo weights is eliminated by status information given on the POD. Thus, the process for invoicing is streamlined and there are fewer disputes. The expense resulting from time incurred with multiple crediting and debiting of the manufacturer by the TSP, as was often the case in the conventional invoicing method, is greatly reduced. In addition, the TSP has an added incentive to expedite its shipments, as the invoice will not be paid until the POD is received.

The self-invoicing method of the present invention allows the manufacturer adequate time to review the invoice, enabling the manufacturer to pay the correct amount to the TSP on time. The TSP has an obligation to audit, via a report issued to them, the billed amount. The manufacturer pays the correct amount determined by the system unless informed otherwise by the TSP. Hence the present invention provides the manufacturer with better control over the invoicing process.

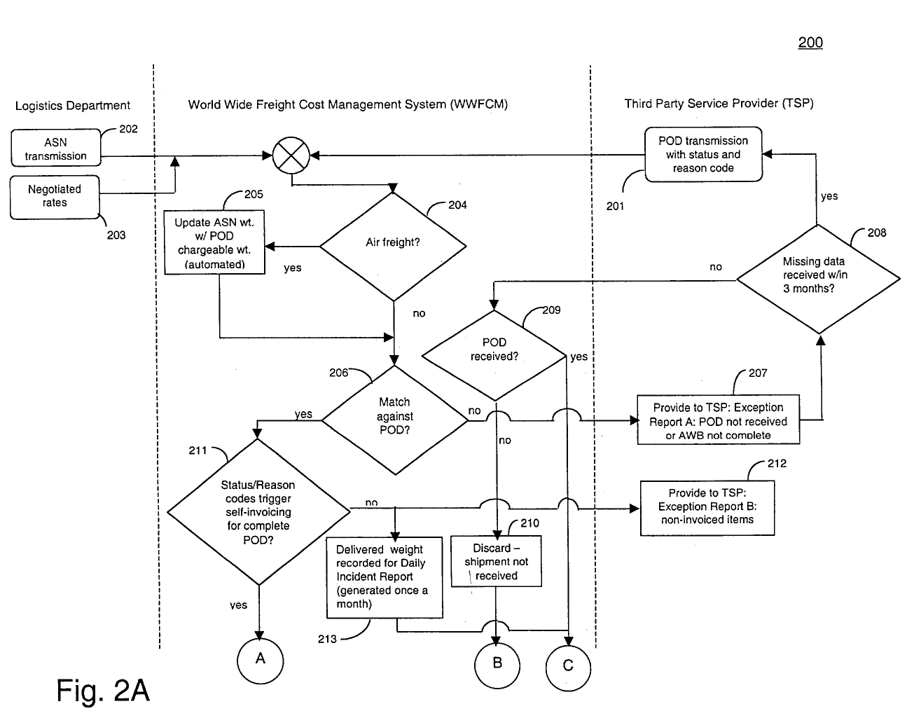

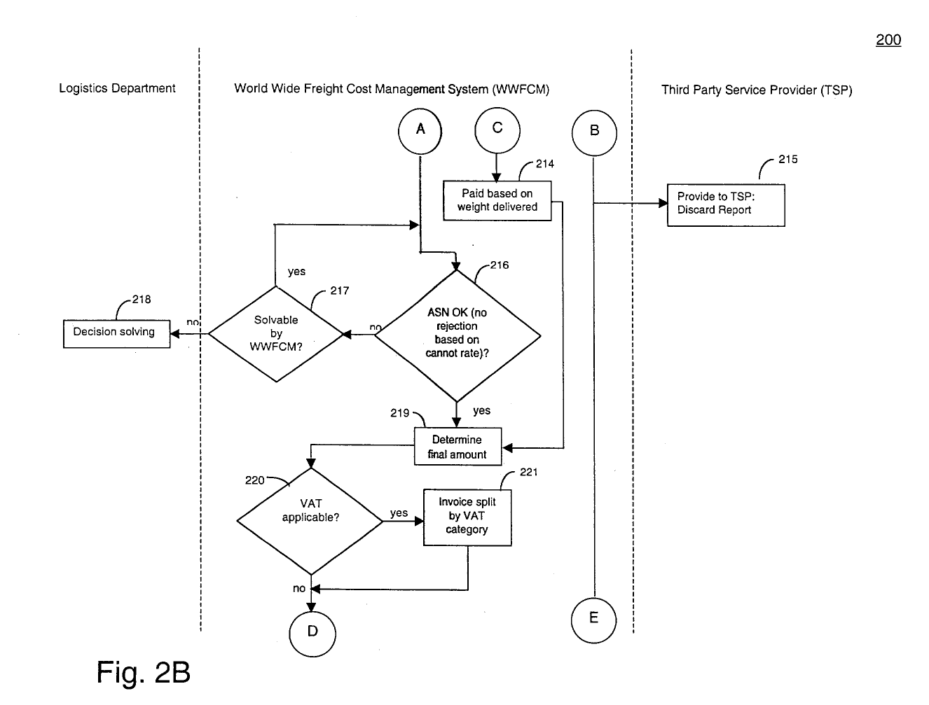

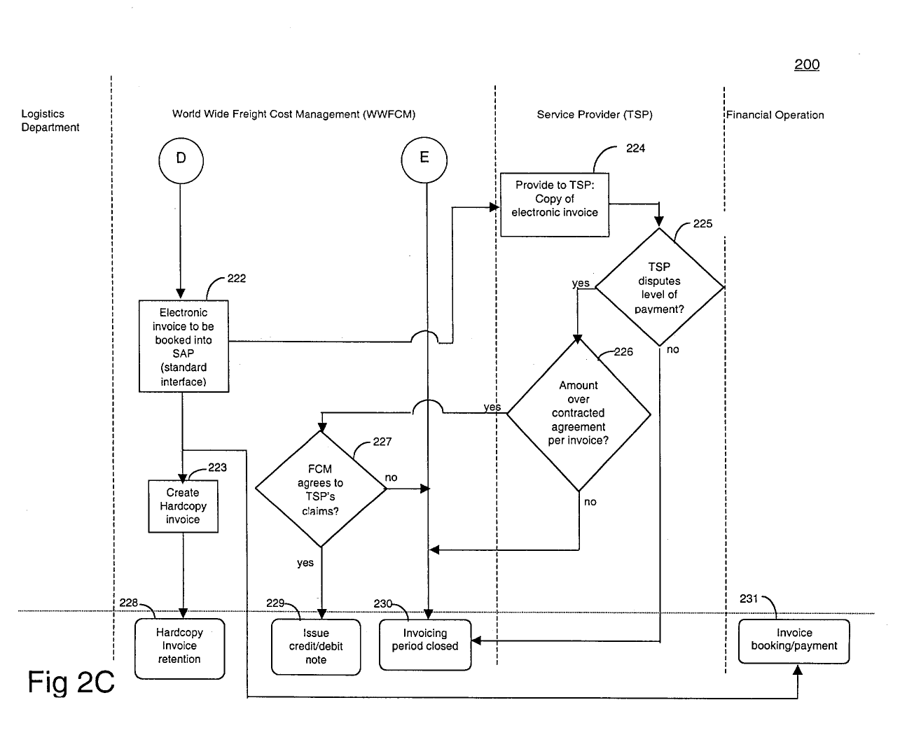

Certain portions of the detailed descriptions of embodiments of the invention, which follow, are presented in terms of processes and methods (e.g., method 200 of FIGS. 2A, 2B and 2C). Although specific steps are disclosed herein describing the operations of these processes and methods, such steps are exemplary. That is, embodiments of the present invention are well suited to performing various other steps or variations of the steps recited in the flowcharts of the figures herein.

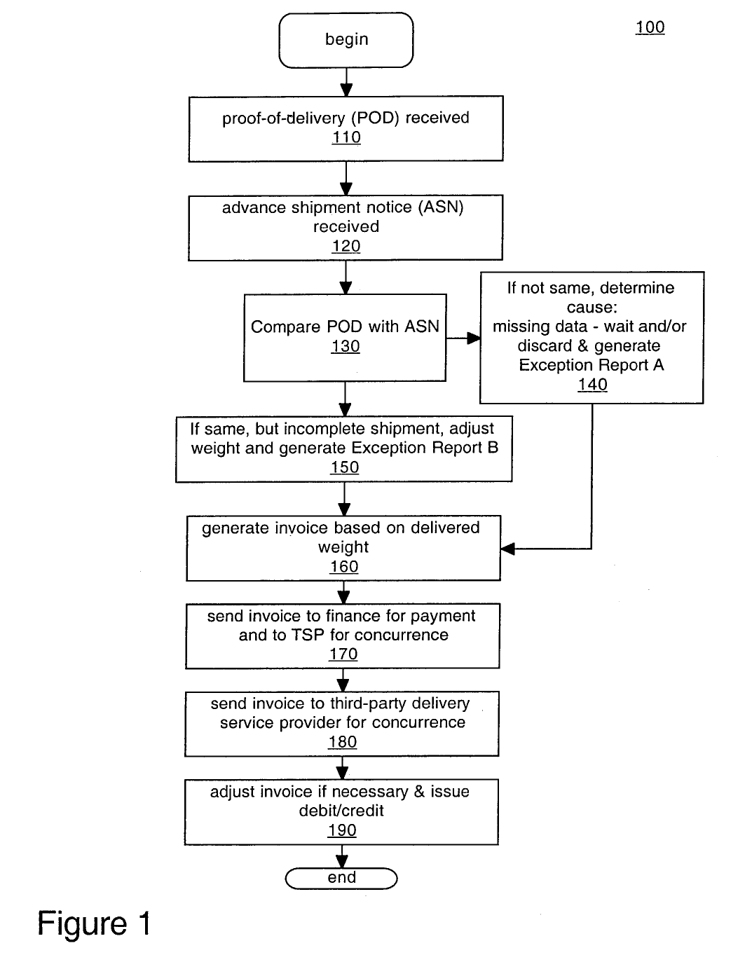

Refer now to FIG. 1, a flow diagram of method 100, in accordance with one embodiment of the present invention, for achieving control of invoicing for third-party delivery services is presented. The following discussion will describe the steps of method 100 of FIG. 1 in conjunction with the steps of FIGS. 2A, 2B and 2C. FIGS. 2A, 2B and 2C contain a flow chart for method 200 of self-invoicing for freight cost management, in accordance with one embodiment of the present invention. FIGS. 2A and 2B are divided into three sections. The blocks that fall in the left section of the flowchart represent actions taken by the manufacturer's Logistics Department. The blocks that fall in the middle section represent actions taken be the manufacturer's automated Freight Cost Management System. The blocks that fall in the right section represent interactions between the Freight Cost Management System and the TSP. FIG. 2C has a fourth section for interfacing with the manufacturer's Financial Operation. Again, it should be noted that, although the foregoing discussion explicitly recites activities that are associated with Freight Cost Management, actions affiliated with a client that is a manufacturer and TSPs which are third-party delivery services providers, embodiments in accordance with the present invention are also well suited to use with other types of cost management systems, other types of clients and TSPs that are providers of services other than delivery services.

The following detailed description pertains to a method and system for achieving control of invoicing for third-party services. For purposes of clarity and brevity, the following discussion will explain the present method and system with respect to a third-party delivery service provider. It should be noted, however, that although such an example is explicitly provided below, the method and system of the present invention is well suited to use with various other types of third-party services providers including, but not limited to, delivery services providers.

In step 110 of FIG. 1, which corresponds to block 201 of method 200 in FIG. 2A, the proof-of delivery (POD) notice is received by the manufacturer from the third-party service provider (TSP). The proof of delivery will typically contain date of delivery, status/reason delivery codes, chargeable weights, transportation mode and other information called out by the particular manufacturer's shipping procedures. According to one embodiment, the POD can be an electronic notification from the TSP based on a paper POD document that is signed by the customer accepting delivery of the shipment and acquired by the TSP from the customer upon delivery. Again, it should be noted that, although the foregoing discussion explicitly recites a POD, embodiments of the present invention are also well suited to use with other types of proof-of-completion notifications.

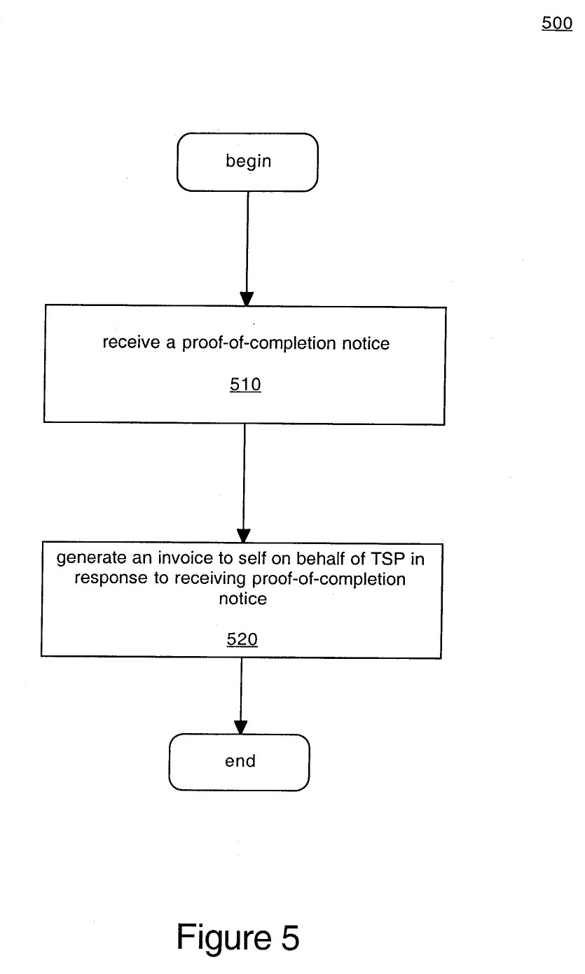

Referring here to step 510 of process 500 as set forth in FIG. 5, in another embodiment of the present invention a proof-of-completion notice is received. The proof-of-completion notice indicates the completion of services as described in a notice of contracted services. A client issues the notice of contracted services. In this case the services may be any of a multitude of services provided under contract to any of a multitude of types of clients.

Referring still to step 110 of FIG. 1, which corresponds to block 201 of method 200 in FIG. 2A, the customer indicates any missing or damaged items when signing for the delivery and this information is then included in the POD transmission. The signed paper POD is typically kept by the TSP and may be subject to audit by the manufacturer. In another embodiment, the POD may be an electronic notification from the customer to the manufacturer. Again, it should be noted that, although the foregoing discussion explicitly recited a TSP which is a third-party delivery services provider and a service provided to a client who is a manufacturer, embodiments in accordance with the present invention are also well suited to use with other types of TSPs and clients.

In step 120 of FIG. 1 and block 202 of FIG. 2A, an Advance Shipment Notice (ASN) is received. More specifically, in embodiments in accordance with the present invention, an ASN is typically generated by a Logistics Department, also sometimes called Transportation Department, within the manufacturer's organization. This notice contains a list of items to be shipped, their shipping weights, the total weight of the shipment and negotiated rates, as indicated in block 203 of FIG. 2A. Again, it should be noted that, although the foregoing discussion explicitly recites receipt of ASNs, embodiments in accordance with the present invention are also well suited to use with other types of notices of contracted services other ASNs.

Referring still to FIG. 1 and FIG. 2A, in step 130 of FIG. 130, which corresponds directly with block 206 of FIG. 2A, the POD is compared with the ASN, in accordance with one embodiment of the present invention. Generally, it is expected that the information contained in both the POD and the ASN would be the same. As shown in blocks 204 and 205 of FIG. 2A, there is sometimes a need for adjusting the information on the ASN when special shipping methods are used. Again, it should be noted that, although the above discussion explicitly recites an ASN and a POD, embodiments in accordance with the present invention are also well suited to use with other types of notices of contracted services and proof-of-completion notifications.

In Block 204, method 200 checks to see if the shipment will go by air freight, as the TSP charges differ for air freight from those for ground shipment (air freight charges are typically based on volumetric weights). If the shipment has been delivered by air freight, the charges are updated on the ASN to reflect the POD charges for air freight shipment.

Once this adjustment is made, then the POD and the ASN are compared, as indicated in step 130 of FIG. 1 and block 206 of FIG. 2A.

Referring still to FIGS. 1 and 2A, 2B and 2C, if an ASN has been entered into the manufacturer's Freight Cost Management System, but a POD has not been received, then, according to one embodiment, a match will not occur at block 206 and step 130. Another reason for a no-match occurrence might be that the electronic POD is received, but is missing the delivery date.

In these instances, step 140 of FIG. 1 is entered and, according to one embodiment, a “missing data” report (Exception Report A) is generated and issued to the TSP, as is also indicated by block 207 of FIG. 2A. Another cause for generating Exception Report A could be an incomplete airway bill (AWB). Again, it should be noted that, although the foregoing discussion explicitly recites a TSP which is a third-party delivery services provider, and an incomplete airway bill, embodiments in accordance with the present invention are also well suited to use with other types of TSPs, and to generate exception reports based on any type of information, either missing or incomplete, that would be relevant to the particular services being provided.

According to one embodiment of the present invention, once Exception Report A is issued, the missing data (e.g., POD or delivery date) should be supplied, as indicated by block 209 of FIG. 2A, within a specified time period, three months, for example. If received within the specified time period, the invoicing method 200 continues on to FIG. 2B.

If the missing information is not received, then the ASN is discarded from the Freight Cost Management System as indicated by block 210 of FIG. 2A.

In block 215 of FIG. 2B, the TSP is provided a discard report and block 230 of FIG. 2C is entered where the invoicing period is closed.

Moving now to step 150 of FIG. 1, in one embodiment, if the POD and the ASN match, but the shipment is incomplete, the shipped weights are adjusted. This is covered in further detail in blocks 211, 212, 213, 214 and 219 of FIGS. 2A and 2B.

In block 211 of FIG. 2A, the POD is interrogated for status or reason codes that would trigger self-invoicing for a complete shipment. If the status/reason codes indicate that the shipment is incomplete, method 200 moves to block 212 and also to block 213. Again, it should be noted that, although the above discussion explicitly recites activities that are specific to delivery services, embodiments in accordance with the present invention are also well suited to use with activities related to other types of services.

At block 212 of FIG. 2A, a second report, Exception Report B, is generated and issued to the TSP in accord with an embodiment of the present invention. Exception Report B lists non-invoiced items that correspond to the undelivered or damaged items indicated by the status/reason codes. Status/reason codes can include, but are not limited to, such items as “damaged”, “partial shipment”, “partial due to theft”, or “partial due to damage”. There may also be an intermediate status/reason code, meaning that the cargo is being retained until an agreement is reached for delivery. These codes indicate to the TSP that the invoice will be adjusted from the weights on the ASN to reflect the actual delivered weight. It should be noted that the non-delivered items are then handled through other operating procedures that are not particularly relevant to the present invention. Again, it should be noted that, although the foregoing discussion explicitly recites status/reason codes which are specific to shipments and delivery services, embodiments in accordance with the present invention are also well suited to use with other types of status/reason codes for types of services other than delivery services.

Still referring to FIG. 2A, at block 213, according to one embodiment of the present invention, the delivered weight of the incomplete shipment is recorded in a Daily Incident Report file for periodic reporting, and the weight is passed on to block 214 of FIG. 2B where it will be entered into the determination of the final billing amount at block 219.

Referring now to step 160 of FIG. 1, in accordance with one embodiment of the present invention, the invoice is generated based on delivered weight. This is covered in further detail in blocks 216-223, 228 and 231 of FIGS. 2B and 2C.

Once it is determined that the POD and the ASN match and that the shipment is complete, a check is made to assure that the rate can be determined. This is indicated in block 216. If the rate cannot be obtained from the recorded rate matrix of the ASN (e.g., the rate was changed or the rate was never recorded for a particular service), the method moves to block 217. Again, it should be noted that, although the foregoing discussion explicitly recites POD, ASN and activities associated with a delivery service, embodiments in accordance with the present invention are also well suited to use with other types of proof-of-completion notifications, notices of contracted services and activities related to the particular services being provided.

At block 217, method 200 checks to see if there is an update or some method of solving the cannot rate problem from within the Freight Cost Management (FCM) System. If so, then the problem is solved and block 216 is re-entered with a rate basis and the ASN is OK. If the problem cannot be solved by the Freight Cost Management (FCM) System, then method 200 moves to block 218.

In block 218 of FIG. 2B, the Logistics Department is given the problem to solve and update the rate matrix, or perform the necessary function to enable the FCM system to determine the rate. Again, it should be noted that, although the foregoing discussion explicitly recites Freight Cost Management system, embodiments in accordance with the present invention are also well suited to use with other types of cost management systems.

Still referring to step 160 of FIG. 1 and now to step 219 of FIG. 2B, once the billing rate is determined method 200 moves to step 219. At step 219, according to one embodiment, the final billing amount is determined. Once the final amount is determined, for European shipments it must be determined at step 220 if a Value Added Tax (VAT) is applicable. This depends on the country of origin and the country of destination and differs throughout Europe.

If, in block 220 of FIG. 2B, it is determined that a VAT is applicable, the method moves to step 221 where the VAT category is determined.

At block 221, the category into which the VAT belongs for the shipment of interest is determined. The invoice is then split by VAT category.

Referring still to step 160 of FIG. 1 and now to block 222 of FIG. 2C, in one embodiment of the present invention, the electronic invoice is booked into the Accounts Payable System of the manufacturer's accounting system. The invoice can include, but is not limited to, the tax data of both the manufacturer and the TSP, a TSP code, a business unit number, an invoice number, a date of invoice, a shipment ID, a currency code, a freight amount, a destination, a destination postal code, a destination country, a number of boxes, a shipment weight, a zone, a service level, a subtotal, a VAT amount and a total. Again, it should be noted that, although the foregoing discussion explicitly recited activities associated with a TSP that is a third-party delivery services provider, and a manufacturer as the client, embodiments in accordance with the present invention are also well suited to use with other types of TSPs and clients.

Referring here to FIG. 5, at step 520 an invoice is generated to self on behalf of a TSP in response to receiving a proof-of-completion notice. Here “self” is referring to a client of the TSP, the client being any one of a multitude of businesses that utilize third-party providers. For example, the TSP could be a technical writing service business and the client might be an engineering firm that had contracted the technical writing services to generate a document on the behalf of the engineering firm. Here, the engineering firm would generate an invoice to themselves on behalf of the technical writing services business.

Still referring to step 160 of FIG. 1, and now to block 223 of FIG. 2C, method 200, in accordance with one embodiment, generates a hard copy of the invoice for record storage.

At block 228 of FIG. 2C, the hard copy of the invoice is filed for historical purposes.

Referring to step 170 of FIG. 1 and block 231 of FIG. 2C, method 200 sends the invoice to the manufacturer's Finance Operation for booking and payment to the TSP. Again, it should be noted that, although the foregoing discussion explicitly recites activities associated with a manufacturer's Finance Operation, embodiments in accordance with the present invention are also well suited to use with other types of client's Finance Operations.

With reference now to step 180 of FIG. 1, in one embodiment the electronic invoice is sent in an electronic data exchange to the TSP for concurrence. This is covered in further detail in blocks 224-227 and 230 of FIG. 2C.

Referring now to block 224 of FIG. 2C, the TSP is provided with an electronic invoice so that the TSP has an electronic record for tax and other purposes and for concurrence. The TSP can then review the invoice and if the TSP has no dispute with the level of payment in the invoice, as shown in block 225, method 200 moves to block 230 and the invoicing period is closed.

If the TSP has a dispute with the level of payment, the amount that the TSP believes should be reflected in the invoice is conveyed. This amount is checked in block 226 and if it is within a minimum/maximum tolerance level previously agreed upon, it is accepted and method 200 moves to step 230 and the invoicing period is closed. Again, it should be noted that, although the above discussion explicitly recites a TSP that is a third-party delivery service provider, embodiments in accordance with the present invention are also well suited to use with other types of third-party services providers.

However, if the disputed amount is over the minimum/maximum tolerance agreed upon, the TSP claims that an additional payment is due. The Freight Management System, at block 227 of method 200, either disagrees or agrees with the TSP's claim.

Referring now to step 190 of FIG. 1, in accordance with one embodiment of the present invention, the manufacturer's Freight Cost Management organization adjusts the invoice if necessary. Referring now to FIG. 2C, if the manufacturer's Freight Cost Management agrees to the claim, method 200 moves to block 229 and issues a credit or debit note to the TSP's account accordingly. If Freight Cost Management does not agree, method 200 moves to block 230 and closes the invoicing period. Again, it should be noted that, although the foregoing discussion explicitly recites activities associated with a manufacturer's Freight Cost Management System, embodiments in accordance with the present invention are also well suited to use with other types of clients and cost management systems.

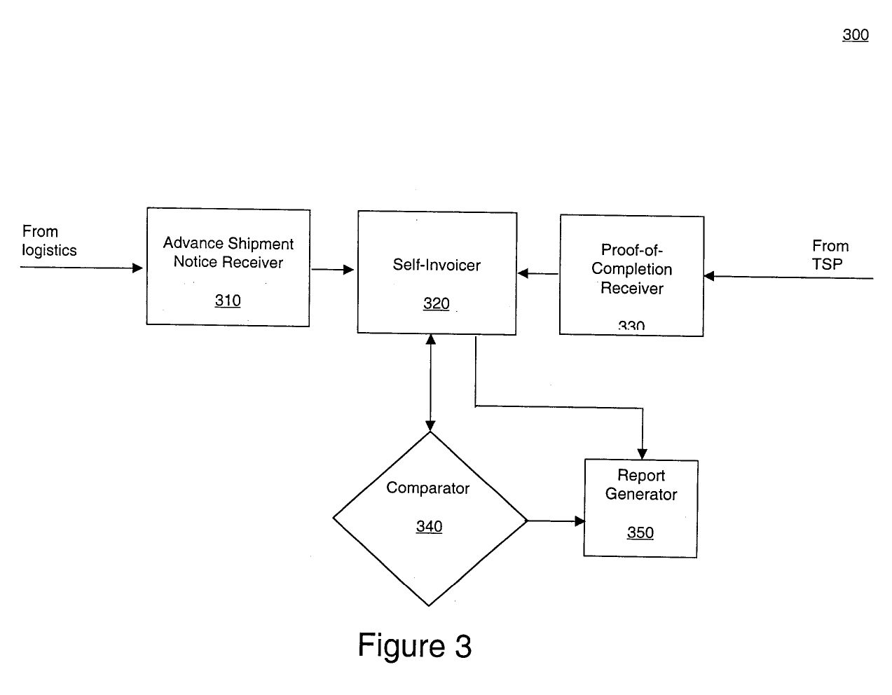

Referring now to FIG. 3, a block diagram of a system 300 for achieving control of invoicing for third-party services is shown, in accordance with one embodiment of the present invention. Advance Shipment Notice (ASN) Receiver 310 receives an ASN from a manufacturer's Logistics Department. This notice contains a list of items to be shipped, their shipping weights, the total weight of the shipment and negotiated rates.

Proof-of-Delivery Completion 330 of FIG. 3 receives a proof-of-completion (e.g., a POD) from a third-party delivery service provider (TSP) that has been contracted to perform a delivery of the shipment specified in the ASN, in accordance with one embodiment of the present invention. The POD will typically contain date of delivery, status/reason delivery codes, chargeable weights, transportation mode and other information called out by the particular manufacturer's shipping procedures. According to one embodiment, the POD can be an electronic notification from the TSP based on a paper POD document that is signed by the customer accepting delivery of the shipment and acquired by the TSP from the customer upon delivery. The customer indicates any missing or damaged items when signing for the delivery and this information is then included in status/reason codes in the POD transmission.

Still referring to FIG. 3, in one embodiment Self-Invoicer 320 receives the ASN and the POD and forwards them to comparator 340.

Comparator 340 compares the ASN and POD and, if the information, e.g., date of delivery, rate structure, etc., match, then the comparator sends the information back to Self-Invoicer 320 for generation of an invoice to the TSP based on the shipped weights and negotiated rates.

Still referring to FIG. 3, if there is data missing in the POD (e.g., date of delivery) or if a POD is not received by Self-Invoicer 320 that aligns with a received ASN, Self-Invoicer 320 send the related information to Report Generator 350.

Report Generator 350 generates an Exception Report A and forwards it to the TSP. Exception Report A indicates the missing information and the TSP is allowed a specified time in which to correct the deficiency. If the deficiency is not corrected within the specified time, the transaction is discarded and the invoicing period is closed.

If Comparator 340 of FIG. 3 finds a match, according to one embodiment it checks further for completeness of shipment. If the shipment is not complete (e.g., missing a pallet), then comparator 340 forwards the information to Report Generator 350.

Report Generator 350 then issues an Exception Report B to the TSP indicating the incomplete shipment and sends the information to Self-Invoicer 320.

Self-Invoicer 320 then modifies the weight according to the delivered weight and generates an invoice accordingly.

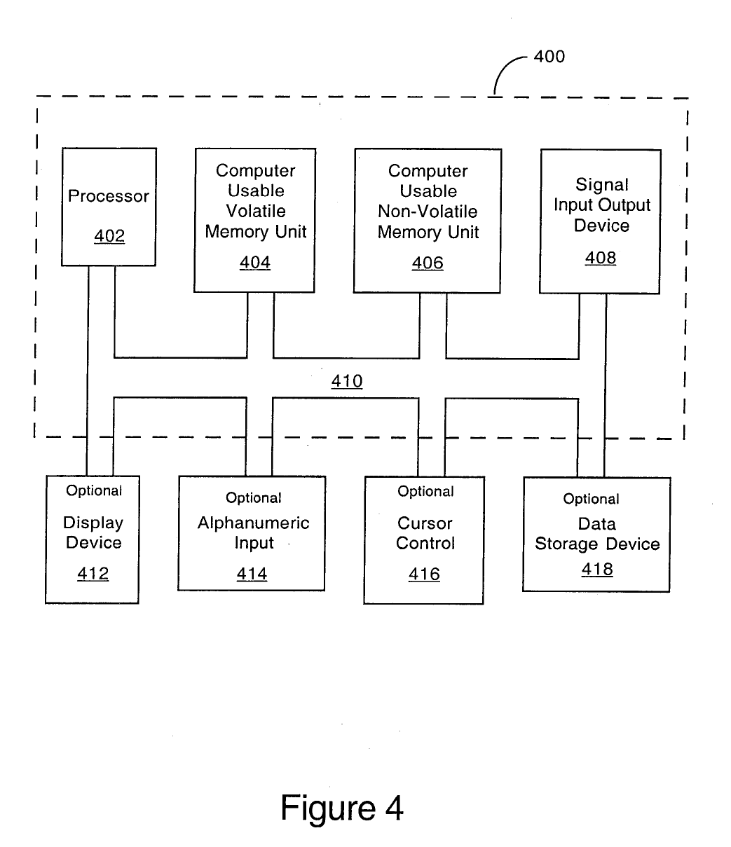

With reference now to FIG. 4, a block diagram of an embodiment of an exemplary computer system 400 used in accordance with the present invention is presented. It should be appreciated that system 400 is not strictly limited to be a computer system. As such, system 400 of the present embodiment is well suited to be any type of computing device (e.g., server computer, portable computing device, desktop computer, etc.). Within the following discussions of the present invention, certain processes and steps are discussed that are realized, in one embodiment, as a series of instructions (e.g., software program) that reside within computer readable memory units of computer system 400 and executed by a processor(s) of system 400. When executed, the instructions cause computer 400 to perform specific actions and exhibit specific behavior that is described in detail herein.

Computer system 400 of FIG. 4 comprises an address/data bus 410 for communicating information, one or more central processors 402 coupled with bus 410 for processing information and instructions. Central processor unit(s) 402 may be a microprocessor or any other type of processor. The computer 400 also includes data storage features such as a computer usable volatile memory unit 404 (e.g., random access memory, static RAM, dynamic RAM, etc.) coupled with bus 410 for storing information and instructions for central processor(s) 402, a computer usable non-volatile memory unit 406 (e.g., read only memory, programmable ROM, flash memory, EPROM, EEPROM, etc.) coupled with bus 410 for storing static information and instructions for processor(s) 402. System 400 also includes one or more signal generating and receiving devices 408 coupled with bus 410 for enabling system 400 to interface with other electronic devices and computer systems. The communication interface(s) 408 of the present embodiment may include wired and/or wireless communication technology.

Optionally, computer system 400 may include an alphanumeric input device 414 including alphanumeric and function keys coupled to the bus 410 for communicating information and command selections to the central processor(s) 402. The computer 400 can include an optional cursor control or cursor directing device 416 coupled to the bus 410 for communicating user input information and command selections to the central processor(s) 402. The cursor-directing device 416 may be implemented using a number of well known devices such as a mouse, a track-ball, a track-pad, an optical tracking device, and a touch screen, among others. Alternatively, it is appreciated that a cursor may be directed and/or activated via input from the alphanumeric input device 414 using special keys and key sequence commands. The present embodiment is also well suited to directing a cursor by other means such as, for example, voice commands.

The system 400 of FIG. 4 may also include one or more optional computer usable data storage devices 418 such as a magnetic or optical disk and disk drive (e.g., hard drive or floppy diskette) coupled with bus 410 for storing information and instructions. An optional display device 412 is coupled to bus 410 of system 400 for displaying video and/or graphics. It should be appreciated that optional display device 412 may be a cathode ray tube (CRT), flat panel liquid crystal display (LCD), field emission display (FED), plasma display or any other display device suitable for displaying video and/or graphic images and alphanumeric characters recognizable to a user.

Embodiments of the present invention comprise computer readable code that can be stored in volatile memory unit 404 and non-volatile memory unit 406, for example. The computer readable code can then be executed by processor 402. Interface with other organizations can then be accomplished via signal input/output device 408, according to one embodiment.

Thus, the present invention provides, in various embodiments, methods and systems for self-invoicing for third party service providers. The foregoing descriptions of specific embodiments have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for achieving control of invoicing for third-party services, comprising:
receiving a proof-of-completion notice; and
generating an invoice to self on behalf of a provider of said third-party services in response to said receiving of said proof-of-completion notice.

2. The method as recited in claim 1 further comprising:
obtaining a notice of contracted services and negotiated rates;
comparing said notice of contracted services with said proof-of-completion notice; and
determining a final cost of services based on said comparing of said notice of contracted services with said proof-of-completion notice.

3. The method as recited in claim 2 wherein, provided said comparing results in no match, issuing a first exception report to said third-party services provider, wherein said first exception report indicates a problem.

4. The method as recited in claim 2 wherein, provided said comparing results in no match, discarding said notice of contracted services and closing an invoicing period if said problem is not corrected within a specified period of time.

5. The method as recited in claim 4 wherein, provided said comparing results in a match and a check for completeness indicates incomplete services rendered, a second exception report is issued and contracted rate is adjusted accordingly.

6. The method as recited in claim 5 wherein said invoice is generated and said third-party services provider is paid based on said contracted rate.

7. The method as recited in claim 6 wherein said invoice is provided to a financial operation for payment and details of said invoice are provided to said third-party services provider for concurrence.

8. A method for achieving control of invoicing for third-party delivery services, comprising:
receiving a proof-of-delivery notice; and
generating an invoice to self on behalf of a provider of said third-party delivery services in response to said receiving of said proof-of-delivery notice.

9. The method as recited in claim 8 further comprising:
obtaining an advance shipment notice and negotiated rates from a logistics department;
comparing said advance shipment notice with said proof-of-delivery notice; and
determining a final cost of delivery based on said comparing of said advance shipment notice with said proof-of-delivery notice.

10. The method as recited in claim 9 wherein, provided said comparing results in no match, issuing a first exception report to said third-party delivery services provider, wherein said first exception report indicates a problem.

11. The method as recited in claim 9 wherein, provided said comparing results in no match, discarding said advance shipping notice and closing an invoicing period if said problem is not corrected within a specified period of time.

12. The method as recited in claim 11 wherein, provided said comparing results in a match and a check for completeness indicates incomplete shipment, a second exception report is issued and delivery weight is adjusted accordingly.

13. The method as recited in claim 12 wherein said invoice is generated and said third-party delivery services provider is paid based on delivered weight.

14. The method as recited in claim 13 wherein said invoice is provided to a financial operation for payment and details of said invoice are provided to said third-party delivery services provider for concurrence.

15. A computer-usable medium having computer-readable code embodied therein for causing a computer system to perform a method for achieving control of invoicing for third-party delivery services, comprising:
receiving a proof-of-delivery notice; and
generating an invoice to self on behalf of a provider of said third-party delivery services in response to said receiving of said proof-of-delivery notice.

16. The computer-usable medium of claim 15 further comprising:
obtaining an advance shipment notice and negotiated rates from a logistics department;
comparing said advance shipment notice with said proof-of-delivery notice; and
determining a final cost of delivery based on said comparing of said advance shipment notice with said proof-of-delivery notice.

17. The computer-usable medium of claim 16 wherein, provided said comparing results in no match, issuing a first exception report to said third-party delivery services provider, wherein said first exception report indicates a problem.

18. The computer-usable medium of claim 17 wherein, provided said comparing results in no match, discarding said advance shipping notice and closing an invoicing period if said problem is not corrected within a specified period of time.

19. The computer-usable medium of claim 17 wherein, provided said comparing results in a match and a check for completeness indicates incomplete shipment, a second exception report is issued and delivery weight is adjusted accordingly.

20. The computer-usable medium of claim 19 wherein said invoice is generated and said third-party delivery services provider is paid based on delivered weight.

21. The computer-usable medium of claim 20 wherein said invoice is provided to a financial operation for payment and details of said invoice are provided to said third-party delivery services provider for concurrence.

22. A system for achieving control of invoicing for third-party delivery services comprising:
a self-invoicer for generating an invoice on behalf of a provider of said third-party delivery services in response to receiving a proof-of-delivery notice; and
a proof-of-delivery receiver coupled to said self-invoicer for receiving a proof-of-delivery from said third-party delivery services provider, such that upon receiving said proof-of-delivery notice said self-invoicer generates said invoice based on information provided by said proof-of-delivery notice.

23. The system of claim 22 further comprising;
a shipment notice receiver coupled to said self-invoicer for receiving an advance shipment notice and negotiated rates from a logistics department;
a comparator coupled to said self-invoicer for comparing said received proof-of-delivery with said received advance shipment notice; and
a report generator coupled to said comparator.

24. The system of claim 23 wherein, when said comparing produces no match, said report generates a first exception report and sends said first exception report to said third-party delivery services provider, said first exception report indicating a problem.

25. The system of claim 24 wherein said advance shipping notice is discarded and an invoicing period is closed if said problem is not corrected within a specified period of time.

26. The system of claim 25 wherein, when said comparing produces a match, said comparator examines said proof-of-delivery for completeness and issues a second exception report to said third-party delivery service provider if shipment is incomplete.

27. The system of claim 26 wherein said self-invoicer generates said invoice and said third-party delivery service provider is paid based on a delivered weight.
